(19) United States
(12) Patent Application Publication
(10) Pub. No.: US 2025/0357531 A1
(43) Pub. Date: Nov. 20, 2025

(54) NEW Li-CONDUCTOR PROTOTYPES IN THE Li-Ca-Zr-O CHEMICAL SPACE FOR SOLID-STATE BATTERIES

(71) Applicant: SAMSUNG ELECTRONICS CO., LTD., Suwon-si (KR)

(72) Inventors: Mahdi AMACHRAA, Cambridge, MA (US); Yan Wang, Brookline, MA (US)

(21) Appl. No.: 18/821,345

(22) Filed: Aug. 30, 2024

Related U.S. Application Data
(60) Provisional application No. 63/647,882, filed on May 15, 2024.

(51) Int. Cl. H01M 10/0562; H01M 10/0525

(52) U.S. Cl. CPC H01M 10/0562; H01M 10/0525; H01M 2300/0077

(57) ABSTRACT

A lithium-containing oxide has one of the following parent compositions: Li2—zCaZr3O8, Li6—zCaZrO6, Li2—zCaZrO4, Li2—zCaZr2O6, or Li6—zCaZr2O8, where z ranges from −1 to 1. A lithium solid-state battery includes an anode, a cathode, and a solid electrolyte, wherein the solid electrolyte includes the aforementioned lithium-containing oxide. Also, a solid-state battery includes an anode, a cathode, and a solid electrolyte, wherein at least one of the anode and the cathode is coated with a coating which includes the aforementioned lithium-containing oxide.

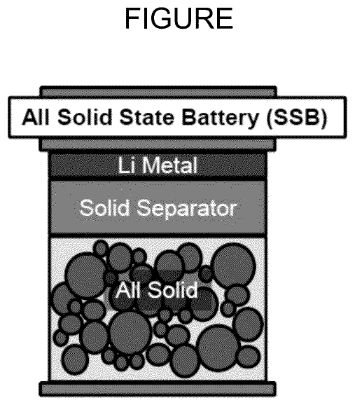

### CROSS-REFERENCE TO RELATED APPLICATION

This application is based on and claims priority from U.S. Provisional Application No. 63/647,882 filed on May 15, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in the FIGURE. In the FIGURE, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H₂S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li—Ca—Zr—O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Ca—Zr—O chemical space by applying a machine learning-based crystal structure prediction algorithm.

In this disclosure, novel lithium-containing oxides include the following parent compositions: Li2—zCaZr3O8, Li6—zCaZrO6, Li2—zCaZrO4, Li2—zCaZr2O6, Li6—zCaZr2O8, where z ranges from −1 to 1.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

A first embodiment of the present disclosure provides a lithium-containing oxide of one of the following parent compositions: Li2—zCaZr3O8, Li6—zCaZrO6, Li2—zCaZrO4, Li2-zCaZr2O6, or Li6—zCaZr2O8, where z ranges from −1 to 1.

A second embodiment of the present disclosure provides a lithium-containing oxide of the first embodiment, wherein the lithium-containing oxide is a lithium-containing oxide of the parent composition Li2—zCaZr3O8, where z ranges from −1 to 1.

A third embodiment of the present disclosure provides a lithium-containing oxide of the first embodiment, wherein the lithium-containing oxide is a lithium-containing oxide of the parent composition Li6—zCaZrO6, where z ranges from −1 to 1.

A fourth embodiment of the present disclosure provides a lithium-containing oxide of the first embodiment, wherein the lithium-containing oxide is a lithium-containing oxide of the parent composition Li2—zCaZrO4, where z ranges from −1 to 1.

A fifth embodiment of the present disclosure provides a lithium-containing oxide of the first embodiment, wherein the lithium-containing oxide is a lithium-containing oxide of the parent composition Li2—zCaZr2O6, where z ranges from −1 to 1.

A sixth embodiment of the present disclosure provides a lithium-containing oxide of the first embodiment, wherein the lithium-containing oxide is a lithium-containing oxide of the parent composition Li6—zCaZr2O8, where z ranges from −1 to 1.

A seventh embodiment of the present disclosure provides a lithium-containing oxide of the first embodiment, wherein the lithium-containing oxide is Li2CaZr3O8.

An eighth embodiment of the present disclosure provides a lithium-containing oxide of the first embodiment, wherein the lithium-containing oxide is Li6CaZrO6.

A ninth embodiment of the present disclosure provides a lithium-containing oxide of the first embodiment, wherein the lithium-containing oxide is Li2CaZrO4.

A tenth embodiment of the present disclosure provides a lithium-containing oxide of the first embodiment, wherein the lithium-containing oxide is Li2CaZr2O6.

An eleventh embodiment of the present disclosure provides a lithium-containing oxide of the first embodiment, wherein the lithium-containing oxide is Li6CaZr2O8.

A twelfth embodiment of the present disclosure provides a lithium-containing oxide of the first embodiment, wherein the lithium-containing oxide is: Li2CaZr2O6 crystallized in space group R-3, Li2CaZr2O6 crystallized in space group Pbca, Li2CaZr2O6 crystallized in space group P-1, Li2CaZr2O6 crystallized in space group C2/m, Li2CaZr3O8 crystallized in space group P213, Li2CaZr3O8 crystallized in space group P63mc, Li2CaZr3O8 crystallized in space group P4332, Li2CaZr3O8 crystallized in space group Cmc21, Li2CaZrO4 crystallized in space group P21/c, Li2CaZrO4 crystallized in space group Pnma, Li2CaZrO4 crystallized in space group Pbcm, Li2CaZrO4 crystallized in space group Pmn21, Li2CaZrO4 crystallized in space group Pnn2, Li2CaZrO4 crystallized in space group P-1, Li2CaZrO4 crystallized in space group 1-42m, Li2CaZrO4 crystallized in space group P32, Li2CaZrO4 crystallized in space group Pna2₁, Li2CaZrO4 crystallized in space group Pc, Li2CaZrO4 crystallized in space group 1222, Li6CaZr2O8 crystallized in space group P-3m1, Li6CaZr2O8 crystallized in space group P-1, Li6CaZrO6 crystallized in space group P-3c1, or Li6CaZrO6 crystallized in space group C2/c.

A thirteenth embodiment of the present disclosure provides a lithium-containing oxide of the seventh embodiment, wherein the Li2CaZr3O8 is crystallized in space group P63mc.

A fourteenth embodiment of the present disclosure provides a lithium-containing oxide of the tenth embodiment, wherein the Li2CaZr2O6 is crystallized in space group C2/m.

A fifteenth embodiment of the present disclosure provides a lithium-containing oxide of the tenth embodiment, wherein the Li2CaZr2O6 is crystallized in space group R-3.

A sixteenth embodiment of the present disclosure provides a lithium-containing oxide of the tenth embodiment, wherein the Li2CaZr2O6 is crystallized in space group P-1.

A seventeenth embodiment of the present disclosure provides a lithium-containing oxide of the tenth embodiment, wherein the Li2CaZr2O6 is crystallized in space group Pbca.

An eighteenth embodiment of the present disclosure provides a lithium solid-state battery comprising an anode, a cathode, and a solid electrolyte, wherein the solid electrolyte comprises a lithium-containing oxide of the first embodiment.

A nineteenth embodiment of the present disclosure provides a solid-state battery of the eighteenth embodiment, wherein the solid electrolyte comprises Li2CaZr3O8, Li6CaZrO6, Li2CaZrO4, Li2CaZr2O6, or Li6CaZr2O8.

A twentieth embodiment of the present disclosure provides a lithium solid-state battery comprising an anode, a cathode, and a solid electrolyte, wherein at least one of the anode and the cathode is coated with a coating which comprises a lithium-containing oxide of the first embodiment.

### BRIEF DESCRIPTION OF DRAWINGS

Example embodiments of the present disclosure will be more clearly understood from the following detailed description taken in conjunction with the accompanying drawings in which:

The FIGURE shows an all solid-state battery.

### DETAILED DESCRIPTION OF EXAMPLE EMBODIMENTS

The present disclosure demonstrates several novel compositions within the Li—Ca—Zr—O chemical space with Li-ion conductivity.

In this disclosure, novel lithium-containing oxides include the following parent compositions: Li2—zCaZr3O8, Li6—zCaZrO6, Li2—zCaZrO4, Li2—zCaZr2O6, Li6—zCaZr2O8, where z ranges from −1 to 1. In this regard, it is noted that there can be lithium deficiency associated with oxygen loss in lithium oxide compounds. A general formula for this disclosure can be, e.g., Li2—zCaZr3O8-w, Li6—zCaZrO6-w, Li2—zCaZrO4-w, Li2—zCaZr2O6-w, Li6-zCaZr2O8-w, where z ranges from −1 to 1 and w ranges from −0.5 to 0.5. This disclosure also includes the general formula Li2—zCaZr3O8-w, Li6—zCaZrO6-w, Li2—zCaZrO4-w, Li2-zCaZr2O6-w, Li6—zCaZr2O8-w, where z ranges from 0 to 1 and w ranges from 0 to 0.5.

In this disclosure, novel Li-ion prototypes within the Li—Ca—Zr—O chemical space include the following parent formulas: Li2CaZr3O8, Li6CaZrO6, Li2CaZrO4, Li2CaZr2O6, Li6CaZr2O8.

The Li2CaZr3O8 composition may crystallize in 4 distinct space groups: P63mc, Cmc21, P213, and P4332, with energies above hull of 14.75, 28.06, 31.41, 43.88 meV/atom respectively. The Li activation energies are 0.78 eV (1-dimensional), 0.78 eV (2-dimensional), 2.77 eV (3-dimensional) for the P63mc phase, 0.74 eV (1-dimensional), 2.21 eV (2-dimensional), 2.23 eV (3-dimensional) for the Cmc21 phase, 1.17 eV (1-dimensional), 1.17 eV (2-dimensional), 1.17 eV (3-dimensional) for the P213 phase, and 0.41 eV (1/2/3-dimensional) for the P4332 phase. The reduction potential against Li for all phases is 0.6 V and the oxidation potential is 3.4 V, suggesting that these materials can be used as anolyte against an alloy anode or graphite anode (in batteries, these materials as solid-state electrolyte can form solid-electrolyte interphases by chemical reaction with electrodes and widen the redox potential window of the electrolytes; this applies to the materials below as well). The reaction energy between the Li2CaZr3O8 prototype crystallized in the P63mc space group and water (H2O) is −0.15 eV/atom suggesting a high stability against water.

The Li6CaZrO6 composition may crystallize in two distinct space groups: P-3c1 and C2/c, with energies above hull of 23.21 and 30.36 me V/atom, respectively. The Li activation energies are 0.54 eV (1-dimensional), 0.54 eV (2-dimensional), 0.67 eV (3-dimensional) for the P-3c1 phase, and 0.55 eV (1-dimensional), 0.55 eV) 2-dimensional), 0.56 eV (3-dimensional) for the C2/c phase. The reduction potential is 0.05 V and the oxidation potential is 2.9 V, suggesting that this material can be used as an anode or anolyte against an alloy anode or graphite anode. The reaction energy between the two phases and water (H2O) is higher than-0.58 eV/atom, suggesting that both compounds are relatively stable in aqueous environment.

The Li2CaZrO4 composition crystallizes in 9 different space groups, namely, P-1, Pnma, Pbcm, Pc, Pnn2, Pna2₁, P21/c, P32, Pmn21, spanning an energy above hull range between 22.0 me V/atom to 58.21 meV/atom. The Li activation energy in the one-dimensional space can be from 0.10 eV to 1.43 eV, in the two-dimensional space can be from 0.63 eV to 1.44 eV, in the three-dimensional space can be from 0.63 eV to 1.88 eV. The reduction potential against Li for all phases is 0.3 V and the oxidation potential is 3.24 V, suggesting that these phases can be used as an anolyte against an alloy anode or graphite anode. The water reaction energy between these phases and H2O is −0.35 eV/atom suggesting a relative stability of these phases in aqueous environment.

The Li2CaZr2O6 composition crystallizes in 4 different space groups, namely, C2/m, R-3, P-1, Pbca, with energies above hull of 20.45 meV/atom, 38.36 meV/atom, 44.08 meV/atom, 48.87 me V/atom. The Li activation energies for the C2/m phase are 0.53 eV (1-dimensional), 0.53 eV (2-dimensional), 0.82 eV (3-dimensional). The Li activation energies for the R-3 phase are 0.63 eV (1-dimensional), 0.64 eV (2-dimensional), 0.64 eV (3-dimensional). The Li activation energies for the P-1 phase are 0.75 eV (1-dimensional), 0.64 eV (2-dimensional), 0.64 eV (3-dimensional). The Li activation energies for the Pbca phase are 0.85 eV (1-dimensional), 0.86 eV (2-dimensional), 1.32 eV (3-dimensional). The reduction potential against Li for all phases is 0.36 V and the oxidation potential is 3.4 V, suggesting that these phases can be used as an anolyte against an alloy anode or graphite anode. The water reaction energy between these phases and H2O is −0.12 eV/atom suggesting a relatively good stability in aqueous environment.

The Li6CaZr2O8 composition crystallizes in two different space groups, namely, P-3m1, and P-1 with energies above hull of 28.12 me V/atom and 60 meV/atom, respectively. The Li activation energy for the P-3 ml phase is 0.72 eV (1-dimensional), 0.72 eV (2-dimensional), 2.71 eV (3-dimensional). The Li activation energy for the P-1 phase is 0.66 eV (1-dimensional), 0.66 eV (2-dimensional), 0.78 eV (3-dimensional). The reduction potential against Li is 0.05 eV and the oxidation potential is 3.17 eV, suggesting that these phases can be used as anodes, or anolyte against an alloy anode or graphite anode. The water reaction energy between these phases and H2O is −0.45 eV/atom and −0.84 eV/atom for the P-3 ml and P-1 phases, respectively. These reaction energies suggest a relatively good aqueous stability.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in all-solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃), calcium oxide (CaO), and zirconium oxide (ZrO₂), and as another example, precursors may consist of lithium oxide (Li₂O), calcium oxide, and zirconium oxide.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | | | | | | | | H2O | | | |
|---|---|---|---|---|---|---|---|---|---|---|---|---|
| Host | | Chemical | Mobile | | | | | | RxN | H2O | | |
| ID | Formula | Space | Ion | E_1 D | E_2 D | E_3 D | Vred | Vox | Energy | Content | Ehull | SPG |
| 23316 | Li2CaZr2O6 | Ca—Li—O—Zr | Li1+ | 0.63 | 0.64 | 0.64 | 0.36 | 3.4 | −0.12 | 0.5 | 38.36 | R-3 |
| 23421 | Li2CaZr2O6 | Ca—Li—O—Zr | Li1+ | 0.85 | 0.86 | 1.32 | 0.36 | 3.4 | −0.12 | 0.5 | 48.87 | Pbca |
| 23854 | Li2CaZr2O6 | Ca—Li—O—Zr | Li1+ | 0.75 | 0.78 | 0.81 | 0.36 | 3.4 | −0.12 | 0.5 | 44.08 | P-1 |
| 24709 | Li2CaZr2O6 | Ca—Li—O—Zr | Li1+ | 0.53 | 0.53 | 0.82 | 0.36 | 3.4 | −0.12 | 0.5 | 20.45 | C2/m |
| 23294 | Li2CaZr3O8 | Ca—Li—O—Zr | Li1+ | 1.17 | 1.17 | 1.17 | 0.6 | 3.4 | −0.26 | 0.5 | 31.41 | P2₁3 |
| 23645 | Li2CaZr3O8 | Ca—Li—O—Zr | Li1+ | 0.78 | 0.78 | 2.77 | 0.6 | 3.4 | −0.15 | 0.5 | 14.75 | P6₃mc |
| 24165 | Li2CaZr3O8 | Ca—Li—O—Zr | Li1+ | 0.41 | 0.41 | 0.41 | 0.6 | 3.4 | −0.26 | 0.5 | 43.88 | P4₃32 |
| 24632 | Li2CaZr3O8 | Ca—Li—O—Zr | Li1+ | 0.74 | 2.21 | 2.23 | 0.6 | 3.4 | −0.24 | 0.5 | 28.06 | Cmc2₁ |
| 23234 | Li2CaZrO4 | Ca—Li—O—Zr | Li1+ | 1.43 | 1.44 | 1.62 | 0.3 | 3.24 | −0.35 | 0.5 | 55.3 | P2₁/c |
| 23346 | Li2CaZrO4 | Ca—Li—O—Zr | Li1+ | 0.95 | 0.98 | 1.56 | 0.3 | 3.24 | −0.35 | 0.5 | 38.99 | Pnma |
| 23388 | Li2CaZrO4 | Ca—Li—O—Zr | Li1+ | 0.6 | 1.02 | 1.17 | 0.3 | 3.24 | −0.35 | 0.5 | 41.23 | Pbcm |
| 23482 | Li2CaZrO4 | Ca—Li—O—Zr | Li1+ | 1.04 | 1.09 | 1.6 | 0.3 | 3.24 | −0.35 | 0.5 | 58.21 | Pmn2₁ |
| 23511 | Li2CaZrO4 | Ca—Li—O—Zr | Li1+ | 0.43 | 0.71 | 0.71 | 0.3 | 3.24 | −0.35 | 0.5 | 43.79 | Pnn2 |
| 23513 | Li2CaZrO4 | Ca—Li—O—Zr | Li1+ | 0.48 | 0.79 | 1.88 | 0.3 | 3.24 | −0.28 | 0.5 | 21.69 | P-1 |
| 23531 | Li2CaZrO4 | Ca—Li—O—Zr | Li1+ | 0.87 | 0.88 | 1.47 | 0.3 | 3.24 | −0.35 | 0.5 | 55.98 | P2₁/c |
| 23713 | Li2CaZrO4 | Ca—Li—O—Zr | Li1+ | 0.52 | 2.32 | 2.32 | 0.3 | 3.24 | −0.35 | 0.5 | 50.55 | I-42m |
| 23749 | Li2CaZrO4 | Ca—Li—O—Zr | Li1+ | 0.1 | 0.63 | 0.63 | 0.3 | 3.24 | −0.35 | 0.5 | 54.46 | P3₂ |
| 23813 | Li2CaZrO4 | Ca—Li—O—Zr | Li1+ | 0.92 | 1.29 | 1.33 | 0.3 | 3.24 | −0.35 | 0.5 | 37.8 | P-1 |
| 23960 | Li2CaZrO4 | Ca—Li—O—Zr | Li1+ | 0.71 | 0.93 | 1.16 | 0.3 | 3.24 | −0.35 | 0.5 | 47.96 | Pna2₁ |
| 23985 | Li2CaZrO4 | Ca—Li—O—Zr | Li1+ | 0.94 | 0.97 | 1.59 | 0.3 | 3.24 | −0.35 | 0.5 | 38.38 | Pnma |
| 23990 | Li2CaZrO4 | Ca—Li—O—Zr | Li1+ | 0.51 | 2.32 | 2.34 | 0.3 | 3.24 | −0.35 | 0.5 | 50.6 | I-42m |
| 24048 | Li2CaZrO4 | Ca—Li—O—Zr | Li1+ | 0.41 | 1.12 | 1.25 | 0.3 | 3.24 | −0.35 | 0.5 | 54.35 | P2₁/c |
| 24143 | Li2CaZrO4 | Ca—Li—O—Zr | Li1+ | 0.69 | 0.94 | 1.17 | 0.3 | 3.24 | −0.35 | 0.5 | 41.66 | Pc |
| 24210 | Li2CaZrO4 | Ca—Li—O—Zr | Li1+ | 0.62 | 2.04 | 2.05 | 0.3 | 3.24 | −0.35 | 0.5 | 49.73 | I-42m |
| 24213 | Li2CaZrO4 | Ca—Li—O—Zr | Li1+ | 0.92 | 1.3 | 1.31 | 0.3 | 3.24 | −0.35 | 0.5 | 37.76 | P-1 |
| 24313 | Li2CaZrO4 | Ca—Li—O—Zr | Li1+ | 1.1 | 1.15 | 1.57 | 0.3 | 3.24 | −0.35 | 0.5 | 58.05 | Pmn2₁ |
| 24363 | Li2CaZrO4 | Ca—Li—O—Zr | Li1+ | 0.69 | 0.9 | 1.18 | 0.3 | 3.24 | −0.35 | 0.5 | 50.21 | Pna2₁ |
| 24533 | Li2CaZrO4 | Ca—Li—O—Zr | Li1+ | 0.53 | 2.28 | 2.29 | 0.3 | 3.24 | −0.35 | 0.5 | 49.72 | I222 |
| 24540 | Li2CaZrO4 | Ca—Li—O—Zr | Li1+ | 0.52 | 2.3 | 2.32 | 0.3 | 3.24 | −0.35 | 0.5 | 50.06 | I-42m |
| 24550 | Li2CaZrO4 | Ca—Li—O—Zr | Li1+ | 0.54 | 2.28 | 2.29 | 0.3 | 3.24 | −0.35 | 0.5 | 49.49 | I-42m |
| 24580 | Li2CaZrO4 | Ca—Li—O—Zr | Li1+ | 0.89 | 0.93 | 1.49 | 0.3 | 3.24 | −0.35 | 0.5 | 50.37 | P2₁/c |
| 23735 | Li6CaZr2O8 | Ca—Li—O—Zr | Li1+ | 0.72 | 0.72 | 2.71 | 0.05 | 3.17 | −0.45 | 0.27 | 28.12 | P-3m1 |
| 24073 | Li6CaZr2O8 | Ca—Li—O—Zr | Li1+ | 0.64 | 0.66 | 0.78 | 0.05 | 3.17 | −0.84 | 0.27 | 59.59 | P-1 |
| 23420 | Li6CaZrO6 | Ca—Li—O—Zr | Li1+ | 0.28 | 0.28 | 0.6 | 0.05 | 2.9 | −0.58 | 0.6 | 54.19 | P-3c1 |
| 23428 | Li6CaZrO6 | Ca—Li—O—Zr | Li1+ | 0.55 | 0.55 | 0.56 | 0.05 | 2.9 | −0.56 | 0.6 | 30.36 | C2/c |
| 24179 | Li6CaZrO6 | Ca—Li—O—Zr | Li1+ | 0.54 | 0.54 | 0.67 | 0.05 | 2.9 | −0.52 | 0.6 | 23.21 | P-3c1 |

As can be seen from the results presented in Table 1, the 0.6 V reduction potential against Li and the 3.4 V oxidation potential for all space groups for the Li2CaZr3O8 composition suggest that the composition can be used as an anolyte against an alloy anode or graphite anode (again, in batteries, these materials as solid-state electrolyte can form solid-electrolyte interphases by chemical reaction with electrodes and widen the redox potential window of the electrolytes; this applies to the materials below as well), and the reaction energy between the Li2CaZr3O8 prototype crystallized in the P63mc space group and water (H2O) is −0.15 eV/atom, suggesting a high stability against water. Also, the 0.5 V reduction potential against Li and the 2.9 V oxidation potential for the Li6CaZrO6 composition suggest that the composition can be used as an anode or anolyte against an alloy anode or graphite anode, and the reaction energy between the two phases and water (H2O) is higher that-0.58 eV/atom, suggesting that both compounds are relatively stable in an aqueous environment. In addition, the 0.3 V reduction potential against Li and the 3.24 V oxidation potential for all phases for the Li2CaZrO4 composition suggest that the composition can be used as an anolyte against an alloy anode or graphite anode in all cases, and the reaction energy between these phases and H2O is higher than −0.35 eV/atom, suggesting a relative stability of these phases in an aqueous environment. Further, the 0.36 V reduction potential against Li and the 3.5 V oxidation potential for all phases of the Li2CaZr2O6 composition suggest that the composition can be used as an anolyte against an alloy anode or graphite anode, and the reaction energy between these phases and H2O is −0.12 eV/atom, suggesting a relatively good stability in an aqueous environment. Moreover, the 0.05 eV reduction potential against Li and the 3.17 eV oxidation potential for all phases of the Li6CaZr2O8 composition suggest that the composition can be used as an anolyte against an alloy anode or graphite anode, and the reaction energy between these phases and H2O is −0.45 eV/atom and −0.84 eV/atom for the P-3 ml and P-1 phases, respectively, suggesting a relatively good aqueous stability.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing oxide of one of the following parent compositions:
Li2—zCaZr3O8,
Li6—zCaZrO6,
Li2—zCaZrO4,
Li2—zCaZr2O6, or
Li6—zCaZr2O8,
where z ranges from −1 to 1.

2. The lithium-containing oxide of claim 1, wherein the lithium-containing oxide is a lithium-containing oxide of the parent composition Li2—zCaZr3O8, where z ranges from −1 to 1.

3. The lithium-containing oxide of claim 1, wherein the lithium-containing oxide is a lithium-containing oxide of the parent composition Li6—zCaZrO6, where z ranges from −1 to 1.

4. The lithium-containing oxide of claim 1, wherein the lithium-containing oxide is a lithium-containing oxide of the parent composition Li2—zCaZrO4, where z ranges from −1 to 1.

5. The lithium-containing oxide of claim 1, wherein the lithium-containing oxide is a lithium-containing oxide of the parent composition Li2—zCaZr2O6, where z ranges from −1 to 1.

6. The lithium-containing oxide of claim 1, wherein the lithium-containing oxide is a lithium-containing oxide of the parent composition Li6—zCaZr2O8, where z ranges from −1 to 1.

7. The lithium-containing oxide of claim 1, wherein the lithium-containing oxide is Li2CaZr3O8.

8. The lithium-containing oxide of claim 1, wherein the lithium-containing oxide is Li6CaZrO6.

9. The lithium-containing oxide of claim 1, wherein the lithium-containing oxide is Li2CaZrO4.

10. The lithium-containing oxide of claim 1, wherein the lithium-containing oxide is Li2CaZr2O6.

11. The lithium-containing oxide of claim 1, wherein the lithium-containing oxide is Li6CaZr2O8.

12. The lithium-containing oxide of claim 1, wherein the lithium-containing oxide is:
Li2CaZr2O6 crystallized in space group R-3,
Li2CaZr2O6 crystallized in space group Pbca,
Li2CaZr2O6 crystallized in space group P-1,
Li2CaZr2O6 crystallized in space group C2/m,
Li2CaZr3O8 crystallized in space group P213,
Li2CaZr3O8 crystallized in space group P63mc,
Li2CaZr3O8 crystallized in space group P4332,
Li2CaZr3O8 crystallized in space group Cmc21,
Li2CaZrO4 crystallized in space group P21/c,
Li2CaZrO4 crystallized in space group Pnma,
Li2CaZrO4 crystallized in space group Pbcm,
Li2CaZrO4 crystallized in space group Pmn21,
Li2CaZrO4 crystallized in space group Pnn2,
Li2CaZrO4 crystallized in space group P-1,
Li2CaZrO4 crystallized in space group 1-42m,
Li2CaZrO4 crystallized in space group P32,
Li2CaZrO4 crystallized in space group Pna2₁,
Li2CaZrO4 crystallized in space group Pc,
Li2CaZrO4 crystallized in space group 1222,
Li6CaZr2O8 crystallized in space group P-3m1,
Li6CaZr2O8 crystallized in space group P-1,
Li6CaZrO6 crystallized in space group P-3c1, or
Li6CaZrO6 crystallized in space group C2/c.

13. The lithium-containing oxide of claim 7, wherein the Li2CaZr3O8 is crystallized in space group P63mc.

14. The lithium-containing oxide of claim 10, wherein the Li2CaZr2O6 is crystallized in space group C2/m.

15. The lithium-containing oxide of claim 10, wherein the Li2CaZr2O6 is crystallized in space group R-3.

16. The lithium-containing oxide of claim 10, wherein the Li2CaZr2O6 is crystallized in space group P-1.

17. The lithium-containing oxide of claim 10, wherein the Li2CaZr2O6 is crystallized in space group Pbca.

18. A lithium solid-state battery comprising an anode, a cathode, and a solid electrolyte, wherein the solid electrolyte comprises a lithium-containing oxide of claim 1.

19. The lithium solid-state battery of claim 18, wherein the solid electrolyte comprises Li2CaZr3O8, Li6CaZrO6, Li2CaZrO4, Li2CaZr2O6, or Li6CaZr2O8.

20. A solid-state battery comprising an anode, a cathode, and a solid electrolyte, wherein at least one of the anode and the cathode is coated with a coating which comprises a lithium-containing oxide of claim 1.
